(19) United States
(12) Patent Application Publication
(10) Pub. No.: US 2017/0374139 A1
(43) Pub. Date: Dec. 28, 2017

(54) CLOUD SERVER SYSTEM

(71) Applicants: DAWNING CLOUD COMPUTING GROUP CO., LTD., Beijing (CN); DAWNING INFORMATION INDUSTRY (BEIJING) CO., LTD, Beijing (CN)

(72) Inventors: Hua NIE, Beijing (CN); Xiaojun YANG, Beijing (CN); Yingqi SUN, Beijing (CN); Xingkui LIU, Beijing (CN); Di ZHANG, Beijing (CN); Chenming ZHENG, Beijing (CN)

(21) Appl. No.: 15/540,453

(22) PCT Filed: Apr. 22, 2015
(86) PCT No.: PCT/CN2015/077171

§ 371 Date: Jun. 28, 2017

(30) Foreign Application Priority Data
Dec. 31, 2014 (CN) 201410856903.X

(51) Int. Cl. H04L 29/08; G06F 13/40; G06F 13/42; H04L 12/861

(52) U.S. Cl. CPC H04L 67/10; H04L 49/9068; G06F 13/4022; G06F 13/4282; G06F 2213/0026

(57) ABSTRACT

Provided is a cloud server system, the system comprising a plurality of multi-root input/output virtualized PCIE switches (MR-IOV Switches) that are interconnected each other. The cloud server system based on the MR-IOV PCIE Switch in the present invention can well meet the design requirements of the cloud servers very well, with a high performance-to-consumption ratio, strong overall service capability, low cost, low power consumption and high energy efficiency. I/O virtualization is realized architecture, thus maximally ensuring the performance of the server.

### TECHNICAL FIELD

The present invention relates to the field of computers, and in particular to a cloud server system.

### BACKGROUND

The design and implementation object of cloud servers are ideal performance-to-consumption ratios, ideal overall service capability, low cost, low power consumption and high energy efficiency.

At present, the design and implementation method of the cloud server in the cloud computing system are mainly to interconnect some small nodes with an Ethernet, as shown in FIG. 1. Here, small nodes mainly refer to System on Chip (SOC), such as CM0 to CM19, which per se has a memory controller, a hard disk interface and an Ethernet interface. Ethernet Switches are a plurality of Ethernet switches.

Although the existing cloud server based on Ethernet interconnection solves problems of low power consumption, low cost and easy implementation in terms of design, the problem of effectively adapting server energy efficiency and cloud computing-oriented typical application loads is not solved. The so-called adaptation is to provide necessary computing resources, memory resources, network resources and storage resources according to application demand.

In view of the problems in the related art, no effective solution is proposed currently.

### SUMMARY

In view of the problems in the related art, the present invention proposes a cloud server system which can well satisfy the design demand of cloud servers.

The technical solution of the present invention is realized as follows.

The present invention proposes a cloud server system.

The system includes a plurality of multi-root input/output virtualized PCIE switches (MR-IOV PCIE Switches), wherein the plurality of the MR-IOV PCIE Switches are interconnected each other.

Each MR-IOV PCIE Switch is provided with an input/output connector PCIE I/O for the access of a standard single-root input/output virtualized PCIE device SR-IOV PCIE.

Each MR-IOV PCIE Switch is connected to a plurality of processors.

The function port of each MR-IOV PCIE Switch satisfies the PCIE specification.

PCIE parameter information of the function port of each MR-IOV PCIE Switch is partially or completely the same.

The SR-IOV PCIE includes at least one of the following: a network device, a storage device and an acceleration device.

The PCIE I/O may be mounted with an NVMe disk or may be mounted with a virtual network card.

The NVMe disk is provided with a private partition or a shared partition for a processor.

Furthermore, the system may further include: a management module for managing the MR-IOV PCIE Switches.

The cloud server processor may be provided with a local PCIE I/O connector which can merely be independently used by this processor and cannot be shared with other processors. The provision of the local I/O is mainly used to solve the local demand problem of some I/O of this processor.

The MR-IOV PCIE Switch based cloud server system in the present invention can well satisfy the design demand of cloud servers, that is, high performance-to-consumption ratio and strong overall service capability, low cost, low power consumption and high energy efficiency. I/O virtualization is realized in terms of architecture, which can maximally ensure the performance of the server.

### BRIEF DESCRIPTION OF THE DRAWINGS

In order to more clearly describe the technical solution in the embodiments of the present invention or the technical solution in the prior art, the accompanying drawings to be used in the embodiments will be described simply hereinafter. Obviously, the drawings described hereinafter are merely some embodiments of the present invention. Those skilled in the art may obtain other drawings according to these drawings without any inventive efforts.

FIG. 1 is a structure view of a cloud server system in the prior art;

FIG. 2 is a structure view of an MR-IOV PCIE Switch;

FIG. 3 is a view of an interconnected structure of a plurality of MR-IOV PCIE Switches according to an embodiment of the present invention; and

FIG. 4 is a structure view of a cloud server system according to the embodiments of the present invention.

### DETAILED DESCRIPTION

Hereinafter, the technical solution in the embodiments of the present invention will be described clearly and completely with the accompanying figures. Obviously, the described embodiments are merely some embodiments of the present invention rather than all embodiments. Based on the embodiments in the present invention, all other embodiments obtained by those skilled in the art all belong to the protection scope of the present invention.

Before illustrating the technical solution of the present invention, in order to more clearly understand the present invention, some technical terms in the art that will appear firstly in the present invention will be explained as follows.

MR-IOV: Multi-Root Input/Output Virtualization;

SR-IOV: Single-Root Input/Output Virtualization;

VF: abbreviation of Virtual Function, a virtual function of PCIE; and

PCIE Switch: PCIE switch. PCIE is an abbreviation of PCIEPCI-Express. PCIE is the latest I/O bus and interface standard in computers. The switch of a plurality of PCIE ports is referred to as a PCIE Switch;

High density server: referring to that a plurality of processors are integrated in a certain server space (such as 4U high standard rack server);

Shared resource: referring to that the processors in a server can share resources such as I/O, network and storage etc. of the system;

Shared I/O: referring to that a plurality of processors may share one physical I/O device;

Virtual network card: referring to PCIE network card having SR-IOV property, and there are a plurality of Virtual Functions (abbreviated as VF) in the PCIE configuration space;

NVMe: NVMe is an abbreviation of NVM Express, which is a host control chip interface for PCIE SSD (solid state disk). Its 1.1 Version and higher Version has SR-IOV property and supports multi-host function.

The present invention realizes a novel cloud server system based on MR-IOV PCIE Switch. Hereinafter, some properties of MR-IOV PCIE Switch will be described in detail.

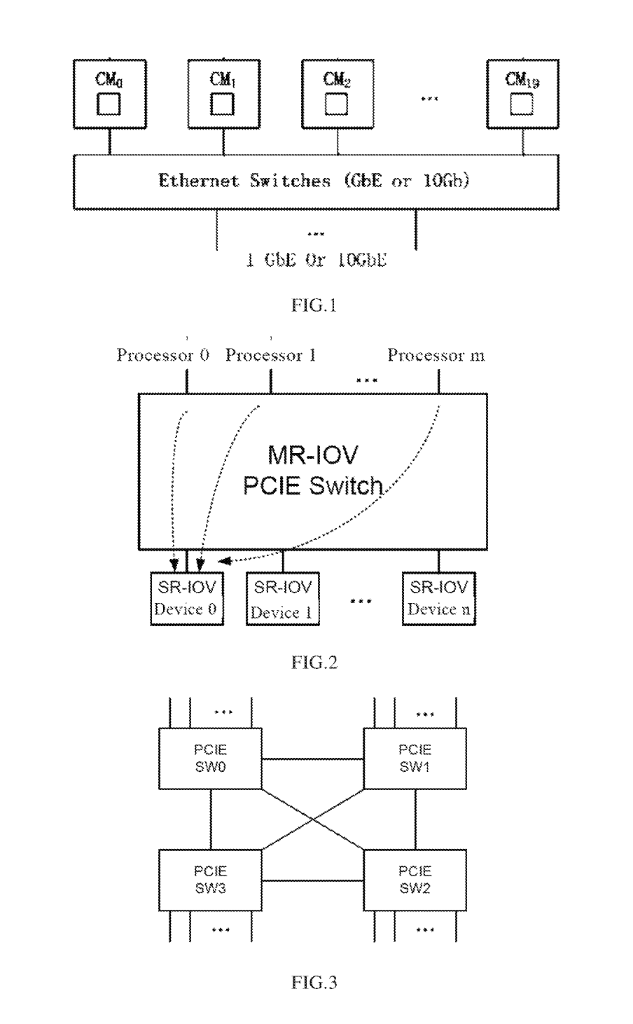

The structure description of MR-IOV PCIE Switch is as shown in FIG. 2.

The primary feature of MR-IOV PCIE Switch is that it is a PCIE switch device. Each port thereof satisfies PCIE specification (the number of Lanes, Gen1/2/3 and so on), as shown in FIG. 2. The PCIE parameters of each port may be different.

There are two classes of switch ports for MR-IOV PCIE Switch: one is uplink port for connecting a processor and the other is downlink port for connecting an I/O device. As shown in FIG. 2, the switch chip has m uplink ports and n downlink ports. Each port of the switch chip may be configured as an uplink or downlink port through hardware or software.

MR-IOV indicates that the downlink I/O device of the switch chip may merely support SR-IOV function, then the SR-IOV PCIE device of this downlink port may be viewed by a processor, which is designated to be connected to an uplink port of the switch chip according to a certain assignment relationship, as being used by a local device. As shown in FIG. 2, different VFs of device 0 of the downlink port are designated to different processor 0, processor 1 and processor m, then processor 0, processor 1 and processor m may operate device 0 simultaneously.

MR-IOV PCIE Switch also has an expansion function, that is, a plurality of MR-IOV PCIE Switches may be interconnected as one MR-IOV PCIE Switch with more ports according to a certain topology. As shown in FIG. 3, four MR-IOV PCIE Switches are interconnected to form one MR-IOV PCIE Switch with more ports.

MR-IOV PCIE Switch supports inter-processor communication.

Based on the property of MR-IOV PCIE Switch above, a cloud server system is provided according to an embodiment of the present invention.

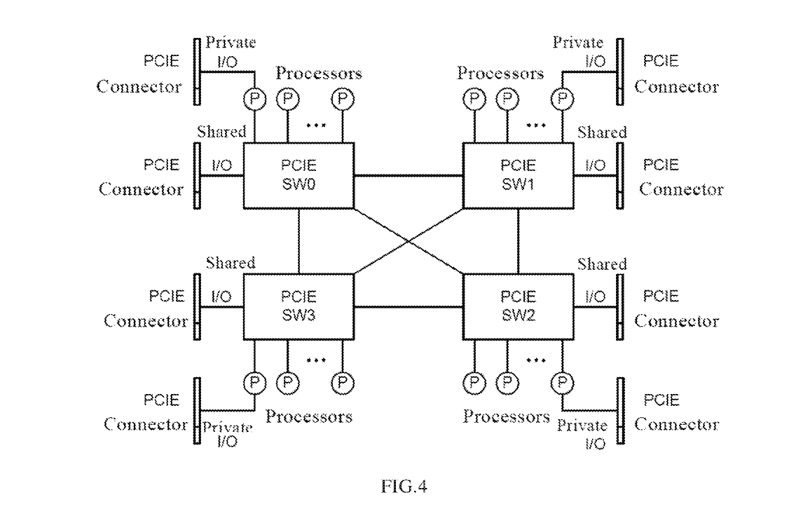

As shown in FIG. 4, the cloud server system according to the embodiments of the present invention includes: a plurality of multi-root input/output virtualized PCIE switches (MR-IOV PCIE Switches), wherein the plurality of MR-IOV PCIE Switches are interconnected each other.

Each MR-IOV PCIE Switch is provided with an input/output connector PCIE I/O for the access of a standard single-root input/output virtualized PCIE device (SR-IOV PCIE).

Each MR-IOV PCIE Switch is connected to a plurality of processors.

The function port of each MR-IOV PCIE Switch satisfies the PCIE specification.

PCIE parameter information of the function port of each MR-IOV PCIE Switch is partially or completely the same.

The SR-IOV PCIE includes at least one of the following: network devices, storage devices and acceleration devices.

The PCIE I/O may be mounted with an NVMe disk or may be mounted with a virtual network card.

The NVMe disk is provided with a private partition or a shared partition for a processor.

Furthermore, the system may further include: a management module for managing the MR-IOV PCIE Switch.

In addition, each cloud server processor may be provided with a local PCIE I/O connector for connecting an I/O device which can merely be independently used by this processor and cannot be shared with other processors. The provision of the local I/O is mainly used to solve the local demand problem of some I/O of this processor.

In order to understand the solution of the present invention more clearly, continuing to refer to FIG. 4, the technical solution of the present invention is further described. Hereinafter, the present invention will be described by taking the interconnection of 4 MR-IOV PCIE Switches as a particular embodiment.

Using the expansion property of MR-IOV PCIE Switch, four MR-IOV PCIE Switches are connected to become a larger-scale MR-IOV PCIE Switch by means of full interconnection topology, which satisfies the processor-intensive design requirement of the cloud server. In this design, each MR-IOV PCIE Switch is connected to 8 processors, and the whole system may be connected to 32 processors.

Each MR-IOV PCIE Switch is provided with a PCIE I/O connector for the access of a standard SR-IOV PCIE device.

Network device: virtual network cards, IB cards and so on.

Storage device: NVMe disks.

Others: other PCIE devices having SR-IOV function, such as acceleration devices and so on.

Based on the above technical solution of the present invention, the present invention can realize storage hardware virtualization and network hardware virtualization.

Storage hardware virtualization refers to: mounting an NVMe disk on a PCIE I/O connector of cloud server based on MR-IOV PCIE Switches on demand. The NVMe disk supports SR-IOV function and can realize multi-host operation. Based on the MR-IOV PCIE Switch configuration architecture in the present invention, each processor in the cloud server may establish a private partition on the NVMe disk. In addition, the cloud server may also establish a shared partition on the NVMe disk to be shared by all processors. This design realizes storage hardware virtualization and the processors share hardware resources. The number and capacity of hard disks may be configured on demand according to the application load situation.

Network hardware virtualization refers to: mounting a virtual network card on a PCIE I/O connector of cloud server based on MR-IOV PCIE Switches on demand. The virtual network card supports SR-IOV function and can realize multi-host operation. Based on the MR-IOV PCIE Switch configuration architecture in the present invention, each processor in the cloud server may drive the virtual network card in the system. In use, the processor uses this virtual network card like using a standard local network card. All processors share this virtual network resource. The bandwidth and transmission priority of the network may be configured on demand according to the application load situation.

In addition, the cloud server system formed according to the technical solution of the present invention may realize the following operations:

1) The high density integration of the cloud server processors is realized by means of expanded connection of MR-IOV PCIE Switch.

2) The cloud server is designed with a PCIE I/O connector connected on MR-IOV PCIE Switch for the access of storage resources, network resources and other resources of the cloud server based on PCIE I/O interfaces.

3) The network sharing of the virtual network card by all processors in the cloud server is realized.

4) The storage sharing of the NVMe disk by all processors in the cloud server is realized.

5) All network and storage resources may be configured on demand according to the typical application demand of cloud computing.

6) The processor of the cloud server may be provided with a local PCIE I/O connector which can merely be independently used by this processor and cannot be shared with other processors. The provision of the local I/O is mainly used to solve the local demand problem of some I/O of this processor.

7) The cloud server is provided with a dedicated management processor for uniformly managing and configuring all MR-IOV PCIE Switches in the system.

In summary, by means of the above technical solution of the present invention, cloud server system architecture based on the MR-IOV PCIE Switches in the present invention can well satisfy the design demand of cloud servers, that is, a high performance-to-consumption ratio and strong overall service capability, low cost, low power consumption and high energy efficiency. I/O virtualization is realized in terms of architecture, which can ensure maximally the performance of the server. In addition, the implementation of storage and network hardware I/O virtualization enables computing nodes to share computing resources, realizing on-demand, simple, elastic, high-throughput cloud server design concept and satisfying the adaptation of different cloud computing application loads by the cloud server.

The foregoing is merely preferred embodiments of the present invention rather than limiting the present invention. Any modifications, equivalent replacements and improvements made within the spirit and principle of the present invention shall all be contained in the protection scope of the present invention.

1. A cloud server system, comprising:
a plurality of multi-root input/output virtualized PCIE switches (MR-IOV PCIE Switches), wherein the MR-IOV PCIE Switch are interconnected each other.

2. The system according to claim 1, wherein each MR-IOV PCIE Switch is provided with an input/output connector PCIE I/O for the access of a standard single-root input/output virtualized PCIE device (SR-IOV PCIE).

3. The system according to claim 1, wherein each MR-IOV PCIE Switch is connected to a plurality of processors.

4. The system according to claim 1, wherein the function port of each MR-IOV PCIE Switch satisfies the PCIE specification.

5. The system according to claim 4, wherein PCIE parameter information of the function port of each MR-IOV PCIE Switch is partially or completely the same.

6. The system according to claim 2, wherein the SR-IOV PCIE includes at least one of the following:
a network device, a storage device and an acceleration device.

7. The system according to claim 2, wherein the PCIE I/O is mounted with an NVMe disk.

8. The system according to claim 2, wherein the PCIE I/O is mounted with a virtual network card.

9. The system according to claim 7, wherein the NVMe disk is provided with a private partition for a processor.

10. The system according to claim 7, wherein the NVMe disk is provided with a shared partition for processors.

11. The system according to claim 1, comprising:
a management module for managing the MR-IOV PCIE Switches.

12. The system according to claim 3, wherein each processor is provided with a PCIE I/O connector for connecting an I/O device which can merely be independently used by the corresponding processor and cannot be shared with other processors.
